(19) United States
(12) Patent Application Publication
(10) Pub. No.: US 2008/0231021 A1
(43) Pub. Date: Sep. 25, 2008

(54) FOLDABLE PUSHCHAIR FOR BABIES AND SMALL CHILDREN

(75) Inventor: Manuel JANE SANTAMARIA, Palau Solita I Plegamans (ES)

Correspondence Address: MERCHANT & GOULD PC, P.O. BOX 2903, MINNEAPOLIS, MN, 55402-0903, US

(73) Assignee: Jane, S.A., Barcelona (ES)

(21) Appl. No.: 12/033,168

(22) Filed: Feb. 19, 2008

(30) Foreign Application Priority Data
Mar. 21, 2007 (ES) 200700618

(51) Int. Cl. B62B 7/08

(52) U.S. Cl. 280/642

(57) ABSTRACT

A pushchair when folded has its sides brought closer together and the rear wheels spaced away with respect to the front wheels. The support of the rear wheels has a pin-jointed connection allowing folding with respect to the corresponding leg. Each of the supports of the rear wheels has a second pin-jointed connection below its pin-jointed connection linking it to the corresponding leg, allowing increasing the degree of folding of the support when folding the pushchair. The supports of the rear wheels form two lengths linked to each other in a pin-jointed connection and are articulately linked to component members of the chassis of the pushchair that when folding, pull the two lengths of said supports to bring about the folding of the rear wheels.

### BACKGROUND OF THE INVENTION

This pushchair is of the type having the two rear legs fitted with the corresponding wheels, in the folded arrangement of the pushchair the wheels with their support being arranged in the prolongation of the legs.

This make-up is a characterizing feature of the so-called umbrella type pushchairs wherein each of the rear legs is articulately linked at its upper end to a respective arm forming the handlebar and ending in a respective handle, each of the front legs being articulately linked to the lower end of the respective one of said arms, these legs being articulately linked to the rear ones by means of two crossed cross members.

These pushchairs can be folded at the middle portion of their sides, these latter being brought closer together when carrying out the folding of the pushchair, this latter nevertheless once having been folded having an appreciable length since the rear wheels have thereby been spaced away from the front ones.

In this type of pushchairs some modifications have been carried out with a view to reduce their length when in the folded arrangement.

These modifications generally consist in articulately linking the supports of the rear wheels to the corresponding legs in order to have said supports folded with respect to the leg when carrying out the folding of the pushchair.

### SUMMARY OF THE INVENTION

This invention has as its object a foldable pushchair for babies and small children allowing to improve the folding of the pushchair thereby having it arranged in a more compact folded arrangement because of obtaining a greater reduction of its length.

For such a purpose a characterizing feature lies in the fact that each of the rear wheel supports has a second pin-jointed connection below its pin-jointed connection linking it to the corresponding leg, this allowing to increase the degree of folding of the actual support when folding the pushchair.

The wheel support has been provided with a stop piece being such as to stabilize the position of the support when the pushchair is arranged in the unfolded arrangement.

The rear wheel supports form two lengths being linked to each other in a pin-jointed connection and are articulately linked to component members of the chassis of the pushchair which when carrying out the folding of this latter pull the two lengths of said supports in order to thus bring about the folding of the rear wheels.

These and other characterizing features will be best made apparent by the following detailed description whose understanding will be made easier by the accompanying sheet of drawings showing a practical embodiment being cited only by way of example not limiting the scope of the present invention.

### DESCRIPTION OF THE DRAWINGS

In the drawings:

FIG. 1 shows in a simplified side elevation the chassis of the foldable pushchair for babies and small children of a conventional type in its folded arrangement;

FIG. 2 depicts in a side elevation the position of the rear wheel support with the pushchair in a folded arrangement when said support is articulately linked to the corresponding leg; and

FIGS. 3, 4 and 5 respectively correspond to perspective views respectively showing: the make-up of the wheel support with the pushchair in the unfolded arrangement; and with the pushchair in the process of being folded; and the arrangement of the wheel in the fully folded arrangement.

### DETAILED DESCRIPTION

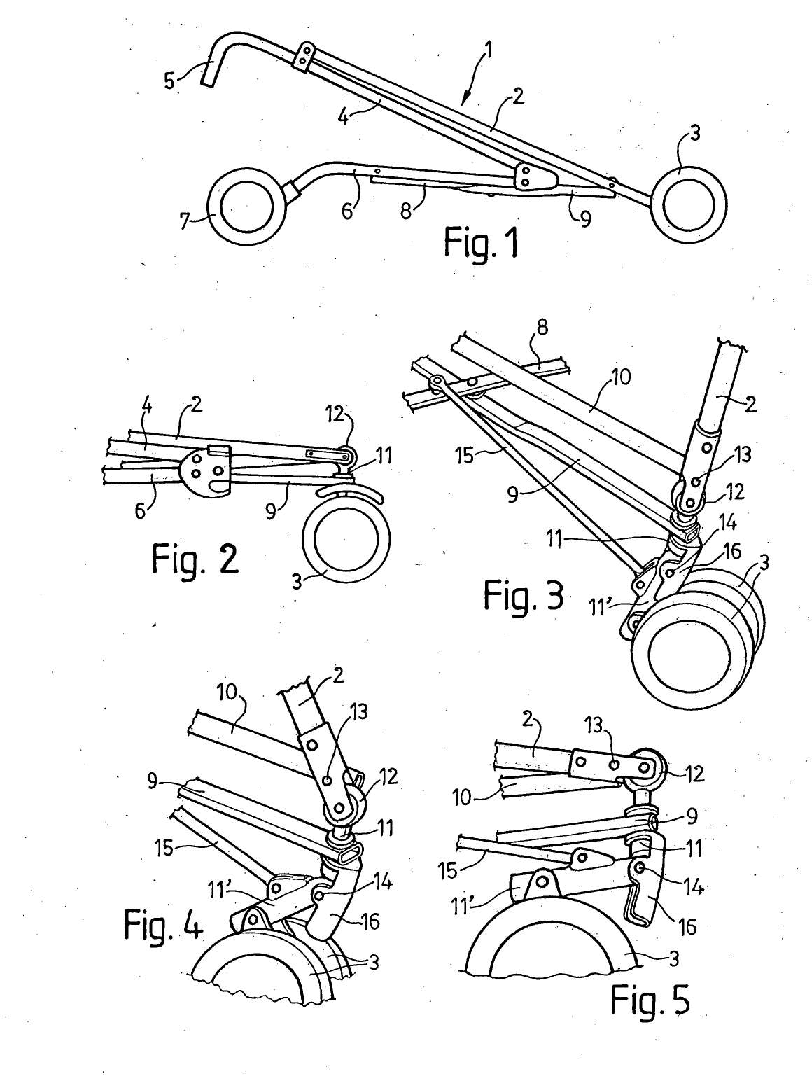

According to the drawings FIG. 1 shows the chassis (1) of a conventional umbrella type pushchair in the folded arrangement, said pushchair comprising two rear legs (2) having the wheels (3) inferiorly fitted to them and being upperly and articulately linked to the arms (4) forming the handlebars and ending in respective handles (5). The arms (4) are inferiorly and articulately fitted to the front legs (6) comprising the corresponding wheels (7). The front legs (6) and the rear legs (2) are articulately connected to each other by means of two crossed cross members (8) and (9), and between the front leg and the rear leg at each side a respective lateral side member (10) is fitted as a support for the seat.

In this pushchair the support (11) of the wheels (3) is fitted to the lower end of the rear legs (2) by means of a pin-jointed connection (12), the corresponding cross member (9) being articulately linked to the lower end of said support (11), the rear end of the corresponding side member (10) being fitted to the lower end (13) of the legs (2).

The main feature of the present invention lies in the fact that the rear wheel supports (11) have a second intermediary pin-jointed connection (14) and thus form two lengths being articulately linked to each other and articulately connected to component members of the chassis of the pushchair which when being folded exert a pulling action on the two lengths of said supports in order to thus bring about the folding of the rear wheels.

The rear wheel supports (11) are articulately linked at their lower length (11′) to joints of the cross members (8 and 9) by means of respective connecting rods (15).

Each of these rear wheel supports (11) has been provided with a respective stop piece (16) being such as to stabilize the position of the support when the pushchair is arranged in the unfolded arrangement (FIG. 3).

In the folding of the pushchair the two crossed cross members (8 and 9) exert at their rear end a pulling action on the upper length of the supports (11), and through the connecting rods (15) they exert a pulling action on the lower length (11′) of said supports. Said lengths (11′) are thereby arranged in a folded arrangement underneath the chassis, in such a way that the rear wheels (3) do not project beyond the end of the folded chassis (FIG. 5).

For pulling the supports (11) when folding the pushchair other components of the pushchair can be used, such as for example lateral side members articulately linking the support of each side to the corresponding front wheel.

1. A foldable pushchair for babies and small children comprising:
sides brought closer together when folded;
front wheels;
rear wheels, each rear wheel having a corresponding support when folded, with first a pin-jointed connection providing for folding with respect to a corresponding leg; wherein the rear wheels are spaced further from the front wheels when folded, and wherein each of the supports of the rear wheels has a second pin-jointed connection below the first pin-jointed connection linking the support to the corresponding leg and increasing the degree of folding of the support when folding the pushchair.

2. A foldable pushchair for babies and small children, as per claim 1, wherein the supports of the rear wheels form two lengths linked to each other in a pin-jointed connection and are articulately linked to component members of a chassis of the pushchair, wherein when folding the pushchair, the component members pull the two lengths of said supports to fold the rear wheels.

3. A foldable pushchair for babies and small children, as per claim 1, wherein the support of the wheels comprises a stop to stabilize the position of the support when the pushchair is in an unfolded position.
